(19) United States
(12) Patent Application Publication
(10) Pub. No.: US 2004/0234858 A1
(43) Pub. Date: Nov. 25, 2004

(54) Positive electrode for lithium secondary battery and lithium secondary battery

(76) Inventors: Mariko Torimae, Kobe-city (JP); Yasuyuki Kusumoto, Kobe-city (JP); Hisaki Tarui, Kobe-city (JP)

Correspondence Address: KUBOVCIK & KUBOVCIK, SUITE 710, 900 17TH STREET NW, WASHINGTON, DC, 20006

(21) Appl. No.: 10/841,824

(22) Filed: May 10, 2004

(30) Foreign Application Priority Data
May 9, 2003 (JP) 2003-131414

(51) Int. Cl. H01M 4/58; H01M 4/66

(52) U.S. Cl. 429/231.95; 429/245; 429/221

(57) ABSTRACT

A positive electrode for a lithium secondary battery having a mixed layer containing an active material including a lithium-containing phosphate having an olivine structure, a conductive agent and a binder on a current collector of a conductive metal foil, wherein a surface roughness (Ra) of a surface of the current collector on which the mixed layer is formed is at least 0.1 μm.

### FIELD OF THE INVENTION

The present inventions relate to a positive electrode for a lithium secondary battery and to a lithium secondary battery.

### BACKGROUND OF THE INVENTION

A lithium secondary battery that comprises a nonaqueous electrolyte and utilizes oxidation and reduction of lithium has recently been used as one of new type secondary batteries having high output and high energy density.

When such lithium secondary batteries having high output and high energy density are put on the market, it is important to take precautions against risks including short-circuiting and overcharging of the batteries, and improper handling, for example, exposing the batteries to high temperatures. When the batteries are left at high temperatures, chemical reactions between materials of the battery are promoted by heat. Various measures have been taken to ensure safety of the batteries. For example, employment of a PTC element, shutting down of overcurrent by using a separator having a low melting point, a current shut down mechanism which operates by an increase of internal pressure of the battery, and the like, have been used. However, it is preferred to develop further measures for safety and to combine several safety measures to increase safety.

A lithium-containing phosphate having an olivine structure has been expected to be useful as a positive electrode material having excellent heat stability during charging as well as having high capacity. Self-heating is unlikely to occur even if a battery including a lithium-containing phosphate having an olivine structure is left under a condition of charging at a high temperature because the phosphate has high heat stability during charging. Therefore, when the lithium-containing phosphate having an olivine structure is used as a positive electrode material, heat stability during charging of a battery can be improved and as a result, stability of the battery can be improved.

As the positive electrode material for a lithium secondary battery, the following publications describe a lithium-containing phosphate having an olivine structure:

Japanese Patent Laid-open Publication No. 2002-216770 [P-1];

Japanese Patent Laid-open Publication No. 2001-338694 [P-2];

Japanese Patent Laid-open Publication No. 2001-110455 [P-3];

Japanese Patent Laid-open Publication No. 2002-117902 [P-4];

Japanese Patent Laid-open Publication No. 2002-117907 [P-5];

Japanese Patent Laid-open Publication No. H9-134725 [P-6];

Japanese Patent Laid-open Publication No. H5-6766 [P-7];

A. K. Padi, K. S. Nanjundaswamy, J. B. Goodenough, J. Electrochem. Soc., 144, 1188 (1997)[Ref-1];

K. Amine, H. Yasuda, M. Yamachi, Electrochem. Solid-State Lett., 3, 178 (2000)[Ref-2];

S. Okada, S. Sawa, M. Egashira, J. Yamaki, M. Tabuchi, H. Kageyama, T. Konishi, A. Yoshino, J. Power Sources, 97-98, 430 (2001)[Ref-3]; and

S. Chung, J. Bloking, Y. Chang, Nature, 1, 123 (2002)[Ref-4]

The lithium-containing phosphate having an olivine structure described in each publication is as follows:

| Phosphate | Publication |
|---|---|
| LiFePO₄, LiFe₁₋ₓMnₓPO₄ (0 ≦ x ≦ 1) | Ref-1 |
| LiMₓFe₁₋ₓPO₄ (0 ≦ x ≦ 0.5, M is at least one metal | P-1 |
| element except for iron) | |
| LiCoPO₄ | Ref-2 |
| LiMPO₄ (M = Co, Ni, Mn or Fe) | Ref-3 and P-2 |
| LiₓM_{y}PO₄ (0 ≦ x ≦ 2, 0.8 ≦ y ≦ 1.2, M is a | P-3 |
| component including 3d transition metal) | |
| LiₓFe_{1-y}M_{y}PO₄ (0.05 ≦ x ≦ 1.2, 0 ≦ y ≦ 0.8, | P-4 and P-5 |
| M = Mn, Cr, Co, Cu, Ni, | |
| V, Mo, Ti, Zn, Al, Ga, Mg, B or Nb) | |
| A_{y}FeXO₄ (0 < y < 2, A: alkali metal, X: an element | P-6 |
| of groups IV˜VII of the periodic table) | |
| Li₁₋ₓMₓFePO₄ (0 ≦ x ≦ 0.01, M = Mg, Al, Ti, Nb, W) | Ref-4 |

However, there is a problem that the lithium-containing phosphate having an olivine structure does not adhere to a metal foil of a current collector. Even if mixed with a binder, the phosphate easily comes off of the current collector. If a layer including a mixture of an active material and a binder is decreased in thickness, it may prevent the layer from coming off. However, if the layer is thin, the ratio of the current collector in a positive electrode becomes greater, and energy density per volume as an electrode is reduced.

There is also a problem that resistance overvoltage and activating voltage are increased during charging and discharging at a large current because a lithium-containing phosphate having an olivine structure has greater electrical resistance as compared with a conventional positive electrode active material, e.g., lithium cobalt oxide. This causes a reduction of voltage of the battery and sufficient charge and discharge capacity may not be obtained. To solve such problem, after the mixed layer is formed on the current collector by coating, it is preferred to press roll the collector to increase density of the active material on the current collector. However, use of a pressing roll is not possible, because, as described above, adhesion of the phosphate to the current collector is poor to press rolling.

### OBJECT OF THE INVENTION

An object of the present inventions is to provide a positive electrode for a lithium secondary battery and a lithium secondary battery that are capable of increasing an amount of coating of an active material and of improving energy density per volume and rate characteristics.

### SUMMARY OF THE INVENTION

A positive electrode for a lithium secondary battery of the present invention comprises a mixed layer comprising an active material including a lithium-containing phosphate having an olivine structure, a conductive agent and a binder on a current collector of a conductive metal foil, wherein a surface roughness (Ra) of a surface of the current collector on which the mixed layer is formed is at least 0.1 μm.

### BRIEF DESCRIPTION OF THE DRAWINGS

FIG. 1 is a drawing illustrating a three-electrode cell prepared for evaluation of the present invention.

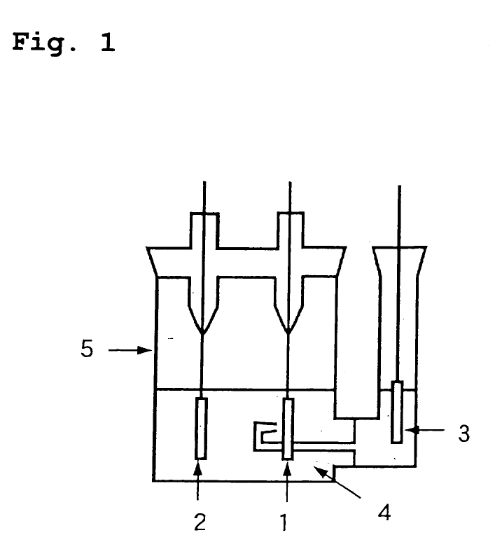

### EXPLANATION OF ELEMENTS

1: working electrode

2: counter electrode

3: reference electrode

4: nonaqueous electrolyte

5: glass cell

### DETAILED EXPLANATION OF THE INVENTION

The surface roughness (Ra) is defined in the Japanese Industrial Standards (JIS B 0601-1994), and can be measured by a surface roughness tester.

When the current collector having a surface roughness (Ra) of at least 0.1 μm is used and the mixed layer is formed thereon, adhesion between the mixed layer and the current collector can greatly improved. As a result, even if a thick mixed layer is formed on the current collector, coming off of the mixed layer can be prevented. Energy density per volume and rate characteristics can be improved.

Increase adhesion between the mixed layer and the current collector makes press rolling possible after the mixed layer is formed on the current collector. If the surface roughness (Ra) of the current collector is less than 0.1 μm, adhesion between the mixed layer and the current collector is poor and press rolling cannot be applied because the mixed layer comes off. According to the present invention, press rolling can be applied. When the mixed layer is press rolled, energy density per volume is improved and contact area between the positive electrode active material and the conductive agent is increased, and conductivity is increased to improve rate characteristics of the electrode.

Japanese Patent Laid-open Publication No. H5-6766 [P-7] discloses a surface roughness (Ra) by center line average height in a range of not smaller than 0.15 μm and not greater than 3.0 μm. However, a conventional positive electrode active material, i.e., lithium-transition metal composite oxide, for example, lithium cobalt composite oxide, lithium cobalt nickel composite oxide, and the like, is used as a positive electrode active material. As explained below, when the conventional lithium-transition metal composite oxide is used as a positive electrode active material, even if a current collector having a small surface roughness (Ra) is used, adhesion between a mixed layer and the current collector is good and it is possible to press roll. In the present invention, it is possible to press roll a material with which a current collector having small surface roughness (Ra) cannot be press rolled by using a current collector having a surface roughness (Ra) of at least 0.1 μm.

When mixed layers are formed on the both sides of the current collector, it is preferred that both surfaces of the current collector have a surface roughness (Ra) of at least 0.1 μm.

A surface roughness (Ra) of 0.15 μm or greater is more preferred, and a surface roughness of 0.2 μm or greater is further preferred. There are no limitations regarding the upper limit of the surface roughness (Ra). However, an upper limit is preferably not greater than 5 μm.

To provide a surface roughness (Ra) of 0.1 μm or greater, the surface of the current collector can be treated. As a method of roughening the surface, polishing, etching, plating, and the like can be illustrated. As polishing, there can be illustrated abrasive blasting, polishing with sand paper, and the like. As etching, physical or chemical etching can be used. Plating is also a method for forming an uneven layer on the surface of the current collector. Plating can be electrolytic or non-electrolytic.

As a conductive metal foil used as the current collector, a metal foil comprising aluminum or an aluminum alloy can be illustrated. Aluminum has a high oxidation potential and the current collector does not melt by oxidation during charging of the positive electrode. Therefore, it is suitable for the positive electrode current collector.

There are no limitations with respect to the thickness of the current collector. However, if the thickness of the current collector is too thick relative to the total thickness of the electrode, the energy density per volume of the electrode is reduced. Therefore, the thickness of the current collector is preferably not greater than 50 μm.

As the lithium-containing phosphate having an olivine structure, a compound represented by the formula LiₓA₁₋ₓFe_{y}M_{z-y}PO₄ (wherein A is an alkali metal, alkali earth metal or transition metal, M is at least one element selected from the group consisting of Co, Ni, Mn, Cu, Zn and Cd, 0<x≦1, 0≦y≦1 and y≦z≦1) can be illustrated. LiFePO₄ and LiCoPO₄ can be illustrated as typical compounds. Each of A and M can be more than two elements and, as such compound, Li_{0.90}Ti_{0.05}Nb_{0.05}Fe_{0.30}Co_{0.30}Mn_{0.30}PO₄ can be illustrated. LiFePO₄ is especially preferably used because an iron compound as a raw material is easily obtained and is inexpensive. A compound including a transition metal, for example, Co, Ni, Mn and the like, instead of iron (Fe), can be expected to provide similar results because the crystalline structures are the same. Other lithium-containing phosphates having an olivine structure as described above can also be used in the present invention.

The positive electrode active material can be a mixture of the lithium-containing phosphate having an olivine structure and other positive electrode active materials.

An electrically conductive network in the mixed layer comprising the positive electrode active material, a conductive agent and the binder is formed around particles of the active material to increase current collectability of the electrode. As a conductive agent an electrically conductive powder and, particularly, conductive carbon powder is preferred. A metal oxide having electrical conductivity can also be used.

An amount of the conductive agent in the mixed layer is preferably not greater than 50 weight % based on the total weight of the mixed layer and, more preferably, is 1˜20 weight %. If the amount of the conductive agent is excessive, the relative amount of the active material is reduced and charge and discharge capacity of the electrode is reduced.

As the binder, any material which can be used as a binder for a lithium secondary battery, can be used. A fluororesin, for example, polyvinylidene fluoride, and the like, can be illustrated. There is no limitation with respect to the amount of the binder. However, 1˜10 weight %, based on the total weight of the mixed layer, is preferred.

In the present invention, preferably after the mixed layer is provided on the current collector, the mixed layer with the underlying current collector is subjected to a press rolling treatment. Press rolling treatment can be done by a press roller and/or a press. Press rolling can increase packing density of the active material in the electrode and can increase energy density per volume. Conditions of the press rolling treatment depend on the equipment to be used. It is preferred to provide the press rolling treatment to obtain a density of the positive electrode active material of at least 1.4 g/cm³. When the density of the positive electrode active material is at least 1.4 g/cm³, energy density per volume can be increased and conductivity in the electrode also can be increased to improve rate characteristics.

In the present invention, an applied capacity of the active material is preferably at least 1.6 mAh/cm². The applied capacity is a capacity of the electrode per area (a designed capacity) obtained by calculation from a theoretical capacity per weight of the active material. The active material containing the lithium-containing phosphate having an olivine structure does not have good adhesion to the current collector. If a current collector having a surface roughness (Ra) of less than 0.1 μm is used, an applied capacity cannot increase. However, according to the present invention, an applied capacity of the active material of at least 1.6 mAh/cm² can be obtained and the energy density per volume as the elctrode can be improved.

The lithium secondary battery of the present invention contains the positive electrode described above, a negative electrode and a non-aqueous electrolyte.

The material for the negative electrode is not limited If the material is capable of reversibly occluding and releasing lithium. A carbon material, for example, graphite, and the like, and a metal capable of occluding lithium by alloying, for example, silicon, tin, aluminum, and the like, can be illustrated.

There are no limitations with respect to the solvent to be used for the nonaqueous electrolyte. Cyclic carbonates, for example, ethylene carbonate, propylene carbonate, butylene carbonate, vinylene carbonate, and the like; chain carbonates, for example, dimethyl carbonate, methylethyl carbonate, diethyl carbonate, and the like, can be used. These solvents can be used alone or in combinations thereof. A mixture of a cyclic carbonate as described above and an ether, for example, 1,2-dimethoxyethane, 1,2-diethoxyethane, and the like, can also be used.

As a solute to be dissolved in the nonaqueous electrolyte, LiPF₆, LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiAsF₆, LiClO₄, Li₂B₁₀Cl₁₀, Li₂B₁₂Cl₁₂, and the like, can be used alone or in various combinations thereof. A mixture of LiXF_{y} (where X is P, As, Sb, B, Bi, Al, Ga or In; and when X is P, As or Sb, y is 6, and when X is B, Bi, Al, Ga or In, y is 4) and lithium perfluoroalkylsulfonylimide, LiN(CₘF₂ₘ₊₁SO₂)(CₙF₂ₙ₊₁SO₂) (where m and n are each independently an integer of 1˜4), or lithium perfluoroalkylsulfonylmethide, LiC(CₚF₂ₚ₊₁SO₂)(C_{q}F_{2q+1}SO₂)(CᵣF₂ᵣ₊₁SO₂) (where p, q and r are each independently an integer of 1˜4) are preferably used. Especially, a mixture of LiPF₆ and LiN(C₂F₅SO₂)₂ is preferred.

As the electrolyte, a gel polymer electrolyte in which the electrolyte is impregnated in a polymer, for example, polyethylene oxide, polyacrylonitrile, and the like, and an inorganic solid electrolyte, for example, LiI, Li₃N, and the like, can also be used. There are no limitations regarding the electrolyte for the present invention as long as the lithium compound as the solute which provides ion conductivity and the solvent in which the lithium compound is dissolved do not decompose during discharge, charge or storage of the battery.

### DESCRIPTION OF PREFERRED EMBODIMENT

Embodiments of the present invention are explained in detail below. It is of course understood that the present invention is not limited to these embodiments and can be modified within the spirit and scope of the appended claims.

(Experiment 1)

[Preparation of Positive Electrode]

LiFePO₄ was prepared as follows. Starting materials of Fe₃(PO₄)₂.8H₂O and Li₃(PO₄)₃ were mixed at a molar ratio of 1:1. The mixture and stainless balls having a diameter of 1 cm were inserted in a stainless pot having a diameter of 10 cm and milled under the conditions described below.

| | |
|---|---|
| Revolution radius: | 30 cm |
| Number of revolutions: | 150 rpm |
| Number of autorotations: | 150 rpm |
| Operating hours: | 12 hours |

The mixture was sintered in an electric furnace at 600° C. for 10 hours in a non-oxidizing atmosphere to obtain LiFePO₄ powder. The obtained powder was confirmed by X-ray diffraction analysis to have an olivine type crystalline structure.

80 parts by weight of the LiFePO₄ powder and 10 parts by weight of artificial graphite powder as the conductive agent were mixed with 5 weight % of N-methylpyrrolidone solution containing 10 parts by weight of polyfluorovinylidene as a binder to prepare a positive electrode mixed slurry.

The slurry was coated on aluminum foil, a current collector, the surface of which was treated by abrasive blasting to provide a surface roughness (Ra) of 0.20 μm, a peak height (Rmax) of 2.2 μm and a thickness of 20 μm. After drying, the coated current collector was subjected to a press rolling treatment. A P.C. controller made by Hitachi Ltd. (model No. PCF1075NH-AM) was used for the press rolling treatment. The coated current collector was inserted between two stainless steel foils (SUS) having a thickness of 0.1 mm and was rolled twice at a rotation speed of 300 rpm. Slit widths of the rollers of 130 μm (an applied capacity of 1.0 mAh/cm²), 140 μm (an applied capacity of 1.6 mAh/cm²) and 150 μm (an applied capacity of 2.1 mAh/cm²) were used. A square (2×2 cm) plate was cut out from each rolled aluminum foil to prepare positive electrodes al having an applied capacity of 1.0 mAh/cm², 1.6 mAh/cm² and 2.1 mAh/cm², respectively.

(Experiment 2)

Three positive electrodes a2 having different applied capacities were prepared in the same manner as Experiment 1 except that an aluminum foil without an abrasive blasting treatment (a surface roughness (Ra) of 0.026 μm, a peak height (Rmax) of 0.59 μm and a thickness of 15 μm) was used.

A press rolling treatment with a slit breadth of rollers of 170 μm (an applied capacity of 1.0 mAh/cm²) and 190 μm (an applied capacity of 1.6 mAh/cm²) were applied. No press rolling treatment for a coated current collector having an applied capacity of 2.1 mAh/cm² was done because the mixed layer came off from the current collector before the treatment.

(Experiment 3)

Three positive electrodes b1 having different applied capacities were prepared in the same manner as Experiment 1 except that LiCoO₂ was used as an active material and the slit breadth of rollers was 130 μm (for all three positive electrodes b1).

LiCoO₂ was prepared as follows. Li₂CO₃ and CoCO₃ were weighed such that an atomic ratio of Li and Co atoms, Li:Co, was adjusted to 1:1 and were mixed in a mortar. The mixture was pressed in a mold having a diameter of 17 mm, and was sintered at 800° C. for 24 hours in air to obtain a sintered LiCoO₂. The sintered LiCoO₂ was ground in a mortar to particles having a mean diameter of 20 μm.

(Experiment 4)

Three positive electrodes b2 were prepares in the same manner as Experiment 3 except that an aluminum foil without surface roughening treatment as in Experiment 2 was used.

[Evaluation of Adhesion Between Mixed layer and Current Collector]

The positive electrodes a1, a2, b1 and b2 were evaluated regarding adhesion of the mixed layers and the current collectors as follows.

◯: The mixed layer did not come off from the current collector after press rolling treatment

X: The mixed layer came off from the current collector after press rolling treatment

XX: The mixed layer came off from the current collector before press rolling treatment

The results are shown in Table 1.

TABLE 1

| | |
|---|---|
| Applied | Adhesion of Mixed |
| Capacity | Layer and Current Collector |

| (mAh/cm²) | a1 | a2 | b1 | b2 |
|---|---|---|---|---|
| 1.0 | ◯ | ◯ | ◯ | ◯ |
| 1.6 | ◯ | X | ◯ | ◯ |
| 2.1 | ◯ | XX | ◯ | ◯ |

As is clear from the results in Table 1, the mixed layer came off the current collector during the press rolling treatment in the positive electrodes a2 in which no surface roughening was applied to the current collector and the applied capacity was 1.6 mAh/cm². When the applied capacity was 2.1 mAh/cm² the mixed layer came off the current collector before the press rolling treatment. In the positive electrode a1 prepared using the current collector with its surface roughened according to the present invention, the mixed layer did not come off from the current collector by the press rolling treatment even if the applied capacity was 1.6 mAh/cm² or more. Therefore, it is confirmed that excellent adhesion between the mixed layer and the current collector can be obtained by using a current collector having a roughened surface even if a greater capacity was applied.

The positive electrodes b1 and b2 prepared using LiCoO₂ as the active material did not show any differences even when the applies capacities were increased. Therefore, the effect of the use of a roughened surface of the current collector to increase adhesion of the mixed layer and the current collector in the positive electrode is useful when a lithium-containing phosphate having an olivine structure is used.

[Measurement of thickness of Mixed Layer and Density of Active Material]

A thickness of the mixed layer and a density of the active material in the positive electrode a1 having the applied capacity of 2.1 mAh/cm² and the positive electrode a2 having the applied capacity of 1.0 mAh/cm² are shown in Table 2.

TABLE 2

| | Thickness of Mixed | Density of Active Material |
|---|---|---|
| Positive | Layer After Press | in Mixed Layer After Press |
| Electrode | Rolling Treatment (μm) | Rolling Treatment (g/cm³) |
| a1 | 79.6 | 1.40 |
| A2 | 44.0 | 1.25 |

As shown in Table 2, the positive electrode a1 is thicker, and the density of the active material in the electrode is 10% greater than the positive electrode a2. According to the present invention even when the applied capacity is increased the mixed layer does not separate from the current collector. Therefore, it is possible to increase an applied capacity and to apply a strong press rolling treatment and increase density of an active material in a mixed layer.

[Preparation of Three-Electrode Cell]

Three-electrode cells A1 and A2 were prepared using the positive electrodes a1 and a2 prepared above. LiPF₆ was dissolved in a mixture of ethylene carbonate and diethyl carbonate in a ratio of 1:1 by volume to a concentration of 1 mol/l to prepare an electrolyte.

The three-electrode cell comprises a working electrode 1, a counter electrode 2, a reference electrode 3, a nonaqueous electrolyte 4 and a glass cell 5. Lithium metal was used for the counter electrode 2 and the reference electrode 3.

[Charge and Discharge Test]

A charge and discharge test was performed for the cells A1 and A2 under the following conditions. Obtained initial discharge capacity and initial energy density per volume of the mixed layer are shown in Table 3.

Charge (occluding lithium to the working electrode):

Constant current charge (Current 0.125 mA/cm², charge end voltage 4.5 V)

Discharge (releasing lithium from the working electrode):

Constant current discharge (Current 0.125 mA/cm², discharge end voltage 2.0 V)

TABLE 3

| | Initial Discharge | Initial Energy Density |
|---|---|---|
| | Capacity per Weight of | per Volume of Mixed |
| Cell | Active Material (mAh/g) | Layer (mWh/cm³) |
| A1 | 150 | 687 |
| A2 | 146 | 623 |

As shown in Table 3, cells A1 and A2 have almost same initial discharge capacities, but cell A1 has about 1.1 times higher initial energy density as compared to cell A2. This is a result of the density of the active material in the mixture layer being increased as shown in Table 2.

[Evaluation of Rate characteristics]

Discharge capacities and average discharge potentials of cell A1 and A2 were measured at a discharge current each of 0.125 mA/cm² and 0.5 mA/cm². Other conditions for charge and discharge are the same as the charge and discharge test described above.

Discharge capacities and average discharge potentials at the discharge current of 0.125 mA/cm² are shown in Table 4, and ones at the discharge current of 0.5 mA/cm² are shown in Table 5.

TABLE 4

| | Discharge | Average |
|---|---|---|
| | Capacity | Discharge Potential |
| Cell | (mAh/g) | (V vs. Li/Li⁺) |
| A1 | 150 | 3.38 |
| A2 | 146 | 3.33 |

TABLE 5

| | Discharge | Average |
|---|---|---|
| | Capacity | Discharge Potential |
| Cell | (mAh/g) | (V vs. Li/Li⁺) |
| A1 | 135 | 3.35 |
| A2 | 134 | 3.17 |

As is clear from the results in Tables 4 and 5, when the cell A1 was discharged at the discharge current of 0.5 mA/cm², the discharge capacity was reduced as compared with that at the discharge current of 0.125 mA/cm², but the average discharge potentials were almost the same at both conditions. When Cell A2 was discharged at the discharge current of 0.5 mA/cm², not only was the discharge capacity reduced, but the average discharge potential was also reduced about 200 mV. This is believed to relate to the fact that when the positive electrode a1 (present invention) was prepared, a strong press rolling treatment was provided and a contact area of the active material, the conductive agent and the current collector was increased and conductivity was improved. Therefore, the present invention can improve rate characteristics.

### ADVANTAGES OF THE INVENTION

The present invention can provide increased applied capacity of an active material and increased energy density per volume and rate characteristics can be improved.

What is claimed is:

1. A positive electrode for a lithium secondary battery comprising a mixed layer comprising an active material including a lithium-containing phosphate having an olivine structure, a conductive agent and a binder on a current collector made of a conductive metal foil, wherein a surface roughness (Ra) of a surface of the current collector on which the mixed layer is formed is at least 0.1 μm.

2. The positive electrode for a lithium secondary battery according to claim 1, wherein the current collector is made of aluminum or aluminum alloy.

3. The positive electrode for a lithium secondary battery C according to claim 1, wherein the lithium-containing phosphate having an olivine structure is a compound containing LiFePO₄.

4. The positive electrode for a lithium secondary battery according to claim 2, wherein the lithium-containing phosphate having an olivine structure is a compound containing LiFePO₄.

5. The positive electrode for a lithium secondary battery according to claim 1, wherein after the mixed layer is formed on the current collector, press rolling is applied thereto.

6. The positive electrode for a lithium secondary battery according to claim 2, wherein after the mixed layer is formed on the current collector, press rolling is applied thereto.

7. The positive electrode for a lithium secondary battery according to claim 3, wherein after the mixed layer is formed on the current collector, press rolling is applied thereto.

8. The positive electrode for a lithium secondary battery according to claim 4, wherein after the mixed layer is formed on the current collector, press rolling is applied thereto.

9. The positive electrode for a lithium secondary battery according to claim 5, wherein a density of the active material on the current collector is 1.4 g/cm³ or more after the press rolling.

10. The positive electrode for a lithium secondary battery according to claim 6, wherein a density of the active material on the current collector is 1.4 g/cm³ or more after the press rolling.

11. The positive electrode for a lithium secondary battery according to claim 7, wherein a density of the active material on the current collector is 1.4 g/cm³ or more after the press rolling.

12. The positive electrode for a lithium secondary battery according to claim 8, wherein a density of the active material on the current collector is 1.4 g/cm³ or more after the press rolling.

13. The positive electrode for a lithium secondary battery according to claim 5, wherein an applied capacity of the active material in the mixed layer is 1.6 mAh/cm² or more.

14. The positive electrode for a lithium secondary battery according to claim 6, wherein an applied capacity of the active material in the mixed layer is 1.6 mAh/cm² or more.

15. The positive electrode for a lithium secondary battery according to claim 7, wherein an applied capacity of the active material in the mixed layer is 1.6 mAh/cm² or more.

16. The positive electrode for a lithium secondary battery according to claim 8, wherein an applied capacity of the active material in the mixed layer is 1.6 mAh/cm² or more.

17. The positive electrode for a lithium secondary battery according to claim 9, wherein an applied capacity of the active material in the mixed layer is 1.6 mAh/cm² or more.

18. The positive electrode for a lithium secondary battery according to claim 10, wherein an applied capacity of the active material in the mixed layer is 1.6 mAh/cm² or more.

19. The positive electrode for a lithium secondary battery according to claim 11, wherein an applied capacity of the active material in the mixed layer is 1.6 mAh/cm² or more.

20. The positive electrode for a lithium secondary battery according to claim 12, wherein an applied capacity of the active material in the mixed layer is 1.6 mAh/cm² or more.

21. A lithium secondary battery comprising a positive electrode according to claim 1, a negative electrode and a nonaqueous electrolyte.

22. A lithium secondary battery comprising a positive electrode according to claim 2, a negative electrode and a nonaqueous electrolyte.

23. A lithium secondary battery comprising a positive electrode according to claim 3, a negative electrode and a nonaqueous electrolyte.

24. A lithium secondary battery comprising a positive electrode according to claim 5, a negative electrode and a nonaqueous electrolyte.

25. A lithium secondary battery comprising a positive electrode according to claim 9, a negative electrode and a nonaqueous electrolyte.

26. A lithium secondary battery comprising a positive electrode according to claim 13, a negative electrode and a nonaqueous electrolyte.
